(19) United States
(12) Patent Application Publication
(10) Pub. No.: US 2014/0089170 A1
(43) Pub. Date: Mar. 27, 2014

(54) FINANCIAL ACCOUNT LABELS

(71) Applicant: Vsevolod Kuznetsov, (US)

(72) Inventor: Vsevolod Kuznetsov, Sankt-Petersburg (RU)

(73) Assignee: RAWLLIN INTERNATIONAL INC., Tortola (VG)

(21) Appl. No.: 13/624,666

(22) Filed: Sep. 21, 2012

(51) Int. Cl. G06Q 40/00

(52) U.S. Cl. 705/39; 705/35

(57) ABSTRACT

Disclosed are electronic systems and techniques for implementing financial account labeling. A labeling component generates a label for an account based in part on data implicitly or explicitly provided by a user associated with the account, and applies the label to a subset of a set of funds maintained in the account. A rules component determines or infers a set of rules for the label based in part on data implicitly or explicitly provided by the user, a set of rule generation criteria, and/or a financial collaborative plan. An access component controls, based in part on the set of rules, transactions relating to the subset of funds corresponding to the label.

### TECHNICAL FIELD

The subject application relates to electronic commerce, and, more particularly, to facilitating consumers of financial services in organizing and restricting access to funds maintained in a financial account.

### BACKGROUND

Developing a plan to achieve a financial goal, and carrying out the plan can be challenging for a large number of consumers. Consumers may face distractions or setbacks that prevent them from achieving a goal, or circumstances that existed when a plan was developed may change over time. A commonly employed solution can be establishing multiple accounts for different purposes. For example, a consumer may have a first savings account for a first purpose, and may have a second joint savings account with other consumers for a second purpose. However, maintaining and keeping track of a number of different accounts can be time consuming and difficult. In addition, consumers maintaining multiple accounts can result in unnecessary expenses for consumers and financial institutions.

Additionally, it is often necessary for consumers to collaborate to achieve a financial goal or execute a financial plan. However, when dealing with financial issues, personal relationships may create discomfort and stress. For instance, some consumers may be uncomfortable discussing financial issues. Similarly, some consumers may feel uncomfortable engaging in financial actions, such as providing funds for an agreed upon purpose, without having some level of control or accountability regarding the funds.

The above-described deficiencies of common financial planning techniques are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for financial account labeling are contained herein. An exemplary system, includes a labeling component configured to generate a label for a subset of a set funds maintained in an account, a rules component configured to determine or infer a set of rules, such as access rules or funding rules, for the label, and an access component configured to, based at least in part on the rules, control access to the subset of funds.

The labels help account holder(s) organize financial deposits into any personal or business budget categories, e.g., Housing, Utilities, Food, Transportation (or subcategories such as car payments, gas, insurance, subway fare, etc.), Clothing, Personal (subcategories such as life insurance, hair care, medical expenses, etc.), Education (subcategories such as tuition, daycare fees, school supplies, etc.), Savings, Credit Cards, etc. Labels not only serve a similar purpose as separate accounts do in that different portions of funds in an account can effectively be made to appear as if it is a separate account for Housing, separate account for Utilities, but additionally, labels allow the same monetary funds to be marked with more than one label so that, for example, a portion of funds can be allocated to either Education or Savings (or additional) purposes. Alternatively, labels can be embodied similar to file folders for portions of account funds, where each file (portion of account funds) may be placed into more than one folder (labels such as Education, Savings, etc.) simultaneously, or vice versa, each file (each label) may be placed into more than one folder (each folder corresponding to a portion of account funds).

Additionally, account owners may assign other co-owners of the account with permissions, such as type of access (e.g., “read-only” (view only) and/or make changes to selected labels, or all labels, on the account) or type of funds transfer (e.g., can deposit funds but not withdraw), or other permissions.

In another non-limiting embodiment, an exemplary method is provided that includes generating a label for an account associated with a first user, applying the label to a subset of a set of funds maintained in the account, determining or inferring a set of rules for the label, and controlling, based at least in part on the rules, access to the subset of funds.

In still another non-limiting embodiment, an exemplary computer readable storage medium is provided that includes initiating a transaction relating to a set off funds corresponding to a label, comparing the transaction against a set of rules for the label, and controlling, based at least in part on the comparison, execution of the transaction.

### BRIEF DESCRIPTION OF DRAWINGS

FIG. 1 illustrates an example financial account labeling system in accordance with various aspects described in this disclosure;

FIG. 2 illustrates an example labeling component in accordance with various aspects described herein;

FIG. 3 illustrates an example rules component in accordance with various aspects described herein;

FIG. 4 illustrates an example access component in accordance with various aspects described herein;

FIG. 5 illustrates an example financial account labeling system in accordance with various aspects described herein;

FIG. 6 illustrates an example label generation pane in accordance with various aspects described herein;

FIG. 7 is an example transaction disposition pane in accordance with various aspects described herein;

FIGS. 8-9 illustrate flow diagrams showing exemplary non-limiting implementations for financial account labeling in accordance with various aspects described herein;

FIG. 10 is a block diagram representing exemplary non-limiting networked environments in which various non-limiting embodiments described herein can be implemented; and

FIG. 11 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

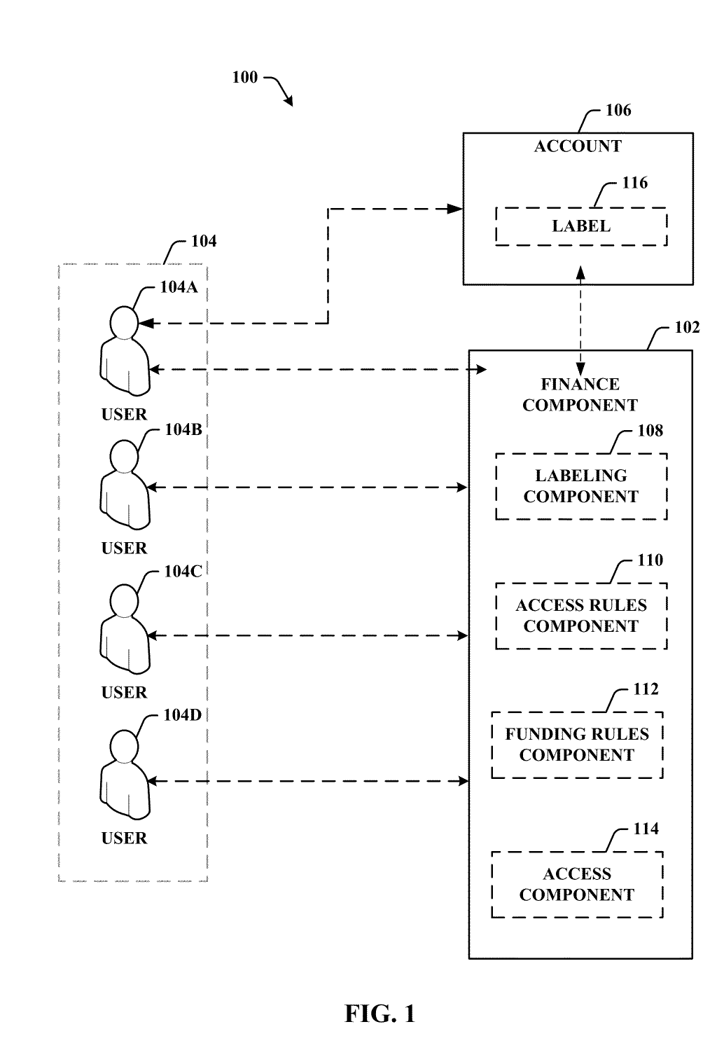

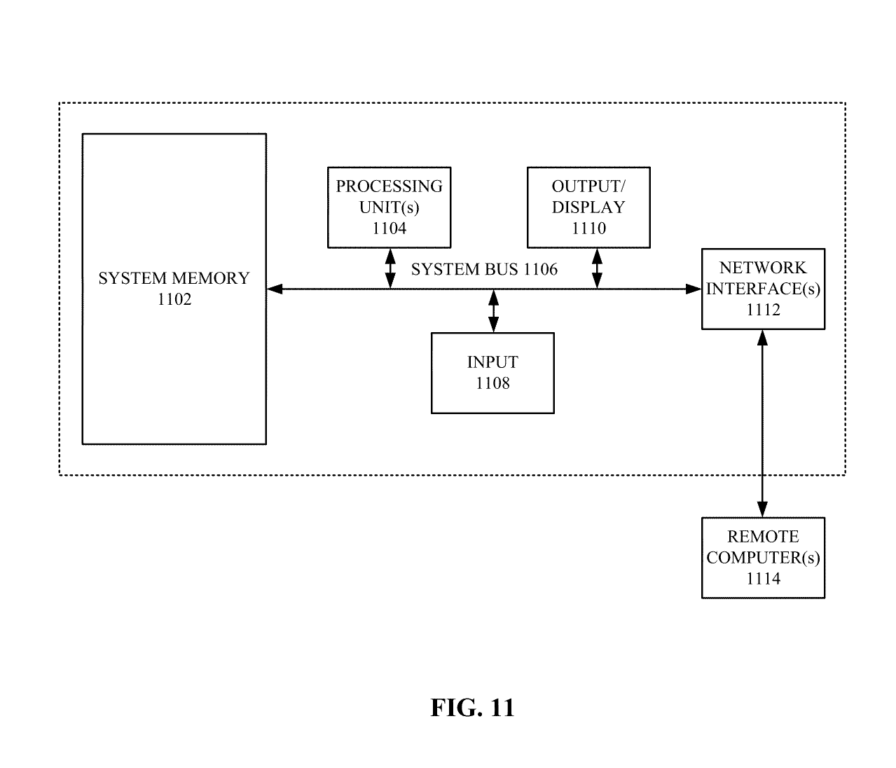

Referring initially to FIG. 1, illustrated is an example financial account labeling system 100 in accordance with various aspects described in this disclosure. Generally, system 100 can include a memory that stores computer executable components and a processor that executes computer executable components stored in the memory, examples of which can be found with reference to FIG. 11. System 100 includes a finance component 102. The finance component 102 provides for organizing, segregating, or otherwise labeling funds maintained in an associated account 106. The account 106 can include but is not limited to a checking account, a savings account, a retirement account, and/or an investment account (e.g., brokerage account, etc.). The finance component 102 includes a labeling component 108, an access rules component 110, a funding rules component 112, and an access component 114. In this regard, as with all components described herein, the access rules component 110 and the funding rules component 112 may be combined in a same rules component or provided as different components, as one of ordinary skill in the software arts can appreciate. The description of such components separately is thus merely to note the concepts separately for descriptive purposes and ease of understanding herein.

The labeling component 108 creates, establishes, or generates a label 116, and appends, attaches, or otherwise associates the label 116 with a set of funds maintained in the account 106. For example, one or more of the users 104 can generate a label 116 for a set of funds maintained in the account 106. Access to funds having the label 116 can be limited, controlled, or otherwise restricted based on a set of rules handled by access rules component 110 (e.g., access criteria, etc.). For example, a first user 104A (e.g., authorized user, primary user, etc.) can generate a “college tuition” label (e.g., label 116). Next, the set of users 104 may want to apply a segment or portion of funds maintained in the account 106 toward college tuition for one or more of the users 104. In order to do that, such funds may be marked with the college tuition label. For instance, the account 106 may belong to a college student (e.g., user 104A), and the set of users 104 may include family members that desire to assist the user 104A with saving for and/or paying the tuition. Optionally, rules from the access rules component 110 can also allow access and management writes per label(s) to third parties, not just co-owners of the account 106. Furthermore, these may include individuals and entities, such as financial brokers, account beneficiaries, government funds, etc.

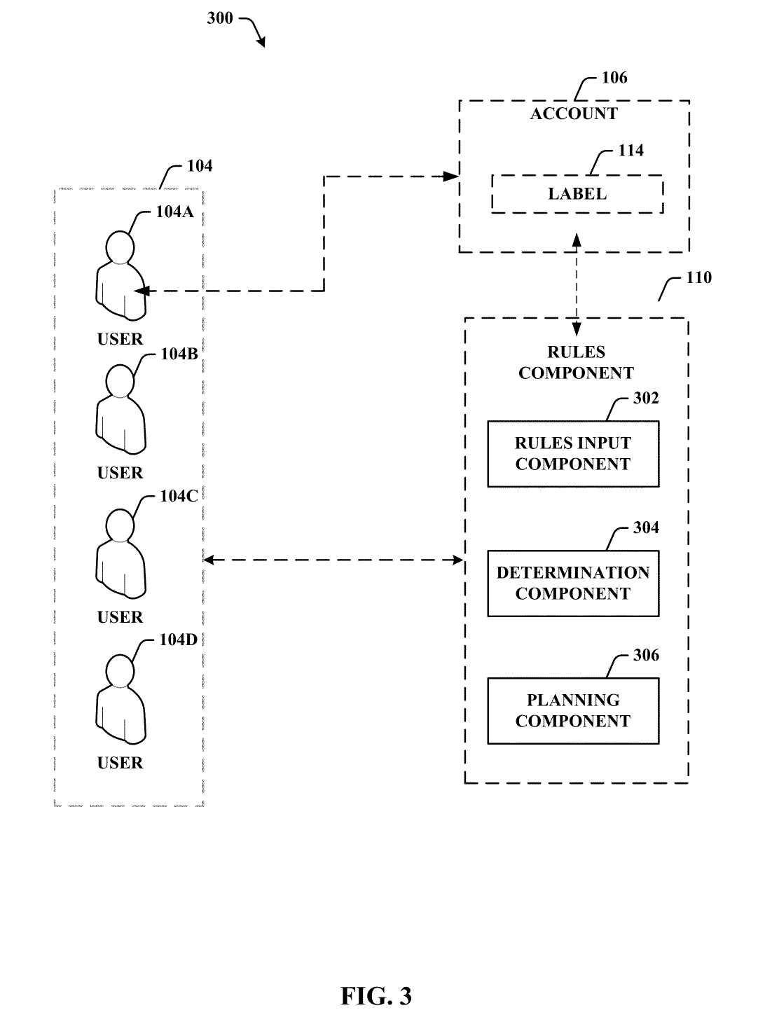

As discussed previously, access to funds corresponding to the label 116 can be restricted based in part on a set of rules. The access rules component 110 determines or infers a set of rules for the label 116. For example, the access rules component 110 can provide for a subset of the users 104 to explicitly or implicitly set, generate, or otherwise determine a subset of the rules (discussed in greater detail with reference to FIG. 3). The set of rules can include but is not limited to permission from a subset of the users 104, occurrence of a predetermined event (e.g., a predetermined date, goal satisfaction, balance requirement, etc.), an authorized expense, an emergency, and/or an authorized payee. Returning to a prior example, access to funds corresponding to the “college tuition” label can be restricted based on an authorized payee, for example, a university attended by the user 104A. This enables the set of users 104 to ensure that funds contributed to the label 116 are applied toward an intended or desired purpose. As an additional or alternative example, access to the funds corresponding to the “college tuition” label can be limited based on obtaining approval from a subset of the users 104. For instance, a second user 104B may be the father of the user 104A, and the user 104A may only be able to withdrawal funds corresponding to the “college tuition” label when permission has been obtained from the user 104B.

As mentioned, together with or separate from, a funding rules component 112 can handle creation, editing, enforcement, deletion, etc. of rules pertaining to sources of funding that can transfer portions to/from the account. These rules may, for example, describe rules for automated transfers from a trunk (roof, unlabeled funds, or other labeled portions of the account or from other accounts, etc.). For another example, rules component 112 can enable the definition of a predefined fixed portion or percentage of all incoming funds that are to be automatically assigned to a selected label or labels, such as “family” or “mortgage” or “rainy day savings”.

The access component 114 restricts, directs, or otherwise controls access to funds corresponding to the label 116 based in part on the set of rules (e.g., determined using the access rules component 110). Access can include but is not limited to transactions including, for example, withdrawals, deposits, transfers, balance inquiries, and/or statement inquiries. For example, only the user 104A may be able to view a balance for the account 106; however, based in part on the set of rules, the set of users 104 may be able to view a balance corresponding to the “college tuition” label (e.g., label 116). It is to be appreciated that the subject innovation is not limited based on a quantity of labels. For example, the account 106 can include Z different labels, where Z is an integer greater than or equal to zero. It is to be further appreciated that although the account 106 and finance component 102 are illustrated as stand-alone components such implementation is not so limited. For example, the account 106 and/or finance component 102 can be included in and/or integrated with a banking system, a financial planning system, and/or a web portal. Furthermore, the same portion of funds, or segment of any portion, may be marked with more than one label. For example, a label “family budget” may be created and any portions of the account balance may be assigned to it. Additionally, a label ‘mortgage’ could be created and one or more portions of funds could be assigned both labels. Furthermore, based on account “funding rules” handled by, e.g., funding rules component 112, a predefined fixed portion or percentage of all incoming funds may be automatically assigned to labels, such as each of these labels in this example.

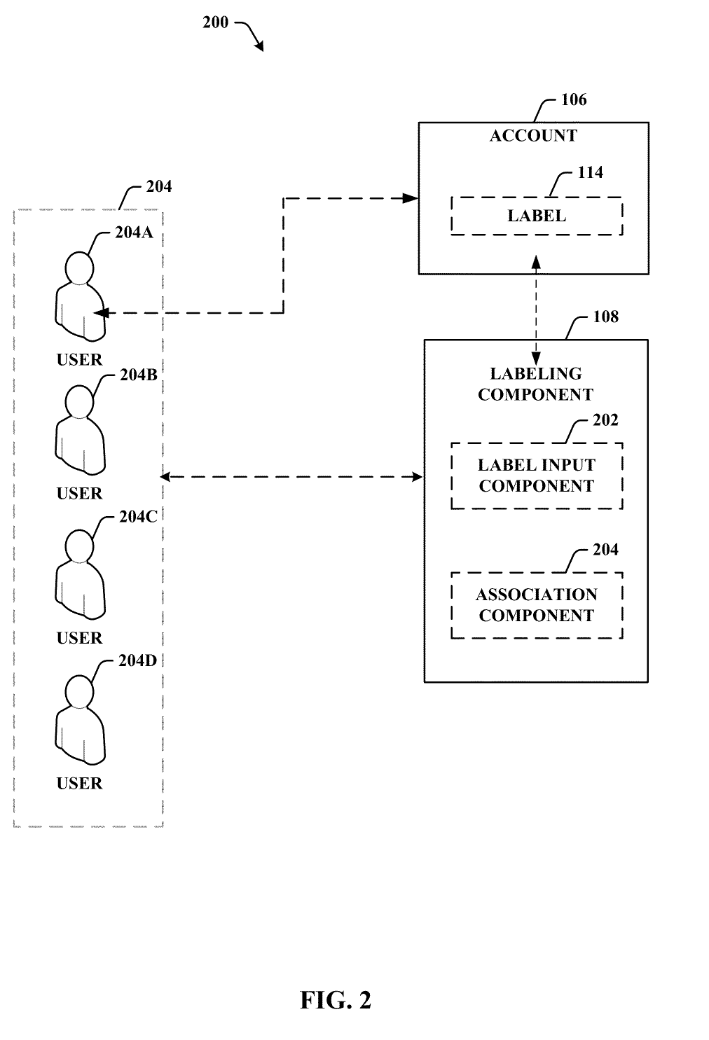

FIG. 2 illustrates an example labeling component 108 in accordance with various aspects described in this disclosure. As discussed previously, the labeling component 108 creates, establishes, or otherwise generates a label 116, and associates the label 116 with a set of funds maintained in the account 106. For example, one or more of the users 104 can generate a label 116 for a set of funds maintained in the account 106, and access to funds corresponding to the label 116 can be limited, controlled, or otherwise restricted based on a set of rules. The labeling component 108 in FIG. 2 includes a label input component 202, and an association component 204.

The label input component 202 obtains, acquires, or otherwise receives inputs or data related to generating a label for a set of funds maintained in an account 106. For example, in one embodiment, the label input component 202 generates, manages, or otherwise controls a user interface, and/or application programming interface (API) to facilitate receiving the input. The input can include but is not limited to explicit user inputs (e.g., configuration selections, question/answer) such as from mouse selections, keyboard selections, speech, and so forth. For instance, a first user 104A can provide data (e.g., title, description, etc.) relating to generating a label 116 via selections and/or fields included in a user interface (e.g., generated using the label input component 202). As an additional or alternative example, in one embodiment, the input can include data uploads, wherein a data upload is a transfer of data from the user or a third party source (e.g. computer or a computer readable medium), to the label input component 202. For instance, a financial planning system and/or a bank not associated with the finance component 102 can provide data related to the label 116 to the label input component 202 (e.g., via an API).

The association component 204 provides for a subset of users (e.g., authorized users, etc.) to assign, apply, or otherwise associate the label 116 with a set of funds maintained in the account 106. For example, W dollars can be maintained in the account 106 (e.g., a balance of W dollars), and a first user can associate the label 116 with less than or equal to W dollars maintained in the account 106, where W is a real number. Additionally or alternatively, the association component 204 provides for one or more users 104 to generate, create, or otherwise determine a set of association criteria for the label 116, and the association component 204 associates the label 116 with a set of funds maintained in the account 106 based in part on the set of association criteria. For example, the user 104A can input a subset of the association criteria via a user interface (e.g., generated by the label input component 202). The association criteria can include but is not limited to a portion (e.g., percentage, predetermined amount, etc.) of deposits made to the account 106, a portion of total (e.g., balance) funds maintained in the account 106, and/or identity of a depositor. For example, the association criteria can include associating funds deposited into the account 106 by users 104B-D with the label 116.

Turning now to FIG. 3, illustrated is an example access rules component 110 in accordance with various aspects described in this disclosure. As discussed previously, the access rules component 110 determines or infers a set of rules for the label 116. For example, the access rules component 110 can enable a subset of the users 104 to set, generate, or otherwise determine a subset of the rules. The set of rules can restrict, direct, or otherwise control transactions (e.g., deposits, withdrawals, transfers, balance inquiries, etc.) relating to funds corresponding to the label 116. For instance, the set of rules can include but is not limited to permission from a subset of the users 104, occurrence of a predetermined event (e.g., a predetermined date, goal satisfaction, balance requirement, etc.), an authorized expense, an emergency, and/or an authorized payee. The rules component in FIG. 3 includes a rules input component 302, a determination component 304, and a planning component 306.

The rules input component 302 obtains, acquires, or otherwise receives inputs or data related to determining one or more rules, such as, but not limited to, rules for access rules component 110 or funding rules component 112. For example, in one embodiment, the rules input component 302 generates, manages, or otherwise controls a user interface, and/or application programming interface (API) to facilitate receiving the input. The input can include but is not limited to explicit user inputs (e.g., configuration selections, question/answer) such as from mouse selections, keyboard selections, speech, and so forth. For instance, a first user 104A can provide data relating to determining the first subset of rules via selections and/or fields included in a user interface (e.g., generated using the rules input component 302). As an additional or alternative example, in one embodiment, the input can include data uploads, wherein a data upload is a transfer of data from the user or a third party source (e.g. computer or a computer readable medium), to the label input component 202. For instance, a financial planning system and/or a bank not associated with the finance component 102 can provide data related to the first subset of rules (e.g., via an API). It is to be appreciated that the rules input component 302 can be included in and/or integrated with the label input component 202.

The determination component 304 determines or infers one or more rules based on a set of rule determination criteria, such as, but not limited to, rules for access rules component 110 or funding rules component 112. The rule determination criteria can include but is not limited to a type of label (label type), contributions of respective users (e.g., users 104), label title or name, label description, rules for labels associated with associated and/or similar users, identity of users, a primary users, and/or other rules associated with the label 116. For example, the determination criteria can determine or infer a rule based on rules for labels associated with different users having a similarity to the label 116 satisfying a similarity threshold.

The planning component 306 determines or infers one or more rules, such as, but not limited to, rules for access rules component 110 or funding rules component 112, based at least in part on a collaborative financial plan associated with one or more of the users 104. The collaborative financial plan can be generated or determined in accordance with methods, systems, or devices, such as those disclosed in commonly owned, co-pending, U.S. patent application Ser. No. 13/623,696 (“the '696 application”), filed Sep. 20, 2012 and titled “COLLABORATIVE FINANCIAL PLANNING” herein incorporated by reference. For example, a collaborative financial plan can include an individual financial plan (e.g., budget, etc.) for the user 104A, and the planning component 306 can determine or infer one or more rules based in part on the individual financial plan. As an additional or alternative example, the planning component 306 can determine or infer one or more rules based in part on a set of goal data associated with a collaborative financial plan, and/or financial information related to a subset of the users 104 participating (participating users) in the collaborative financial plan. The goal data can include but is not limited to a savings and/or investment objective (goal amount), a set of participating users 104, a goal reason and/or description (description), and/or a target completion date (target date). The financial information can include but is not limited to income, account balances, pay dates, expenses (e.g., bills, etc.), approved contribution amounts, and/or income cycles. Additionally or alternatively, the planning component 306 analyzes, examines, or otherwise inspects the collaborative financial plan, goal data, and/or financial information related to the participating users for updates, changes, and/or modifications, and, based on the modifications, removes, adds, or modifies one or more rules. For example, if a price of tuition included in a collaborative financial plan increases, then the planning component 306 can update a subset of the rules based on the price increase.

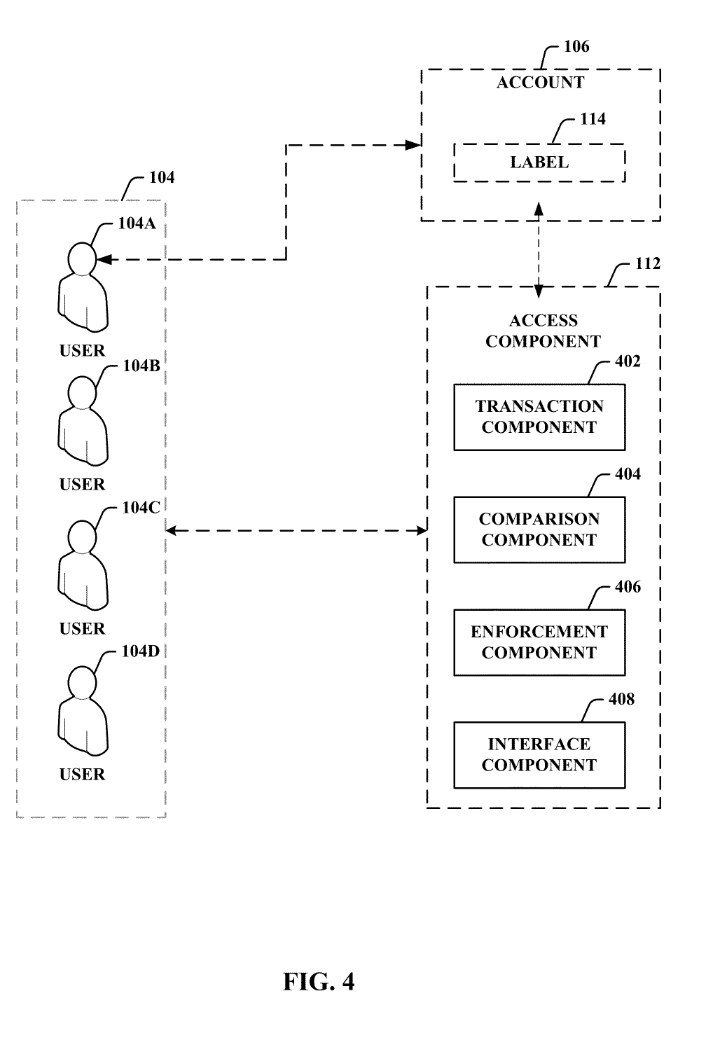

FIG. 4 illustrates an example access component 114 in accordance with various aspects described in this disclosure. As discussed previously, the access component 114 restricts, directs, or otherwise controls, based in part on a set of rules (e.g., determined using the access rules component 110), access to funds corresponding to the label 116. Access can include but is not limited to transactions including, for example, withdrawals, deposits, transfers, balance inquiries, and/or statement inquiries. The access component 114 in FIG. 4 includes a transaction component 402, a comparison component 404, an enforcement component 406, and an interface component 408.

The transaction component 402 enables one or more of the users 104 to initiate a transaction corresponding to the account 106 and/or label 116. As discussed previously, transactions can include but are not limited to withdrawals, deposits, transfers, balance inquiries, and/or statement inquiries. For example, a first user 104A can initiate a withdrawal of funds corresponding to the label 116 via the transaction component 402.

The comparison component 404 compares the initiated transaction against the set of rules (e.g., determined using the access rules component 110), and determines whether the transactions satisfies, conforms to, or otherwise complies with the set of rules. Returning to the previous example, the set of rules for the label 116 can include a predetermined withdrawal date, and the comparison component 404 can compare the date of the initiated withdrawal against the predetermined withdrawal date to determine whether the initiated withdrawal satisfies the set of rules.

The enforcement component 406 implements, executes, or otherwise enforces the set of rules for the initiated transaction. For example, the enforcement component 406 can allow, deny, or otherwise restrict the initiated transaction based in part on the determination of whether the initiated withdrawal satisfies the set of rules (e.g., determined using the enforcement component 406). Returning to the previous example, if the withdrawal date is not satisfied, then the enforcement component 406 can deny the withdrawal. Additional or alternatively, in response to an initiated transaction not satisfying one or more rules, the enforcement component 406 can request permission (e.g., an override) from one or more of other users 104. Returning again to the previous example, in response to the withdrawal date not being satisfied, the enforcement component 406 can request permission from a second user 104B to allow the withdrawal.

The interface component 408 includes any suitable and/or necessary adapters, connectors, channels, communication paths, etc. to integrate the access component 114 into virtually any operating and/or database system(s). Moreover, the interface component 408 can provide various adapters, connectors, channels, communication paths, etc., that provide for interaction with the interface component 408. For example, the interface component 408 can enable the interface component 408 to communicate with unassociated financial institutions, websites, search engines, social networks, and/or shopping portals. It is to be appreciated that although the interface component 408 is illustrated as included in the access component 114, such implementation is not so limited. For example, the interface component 408 can be a stand-alone component, wherein the access component 114 communicates with the interface component 408, for example, using a network connection.

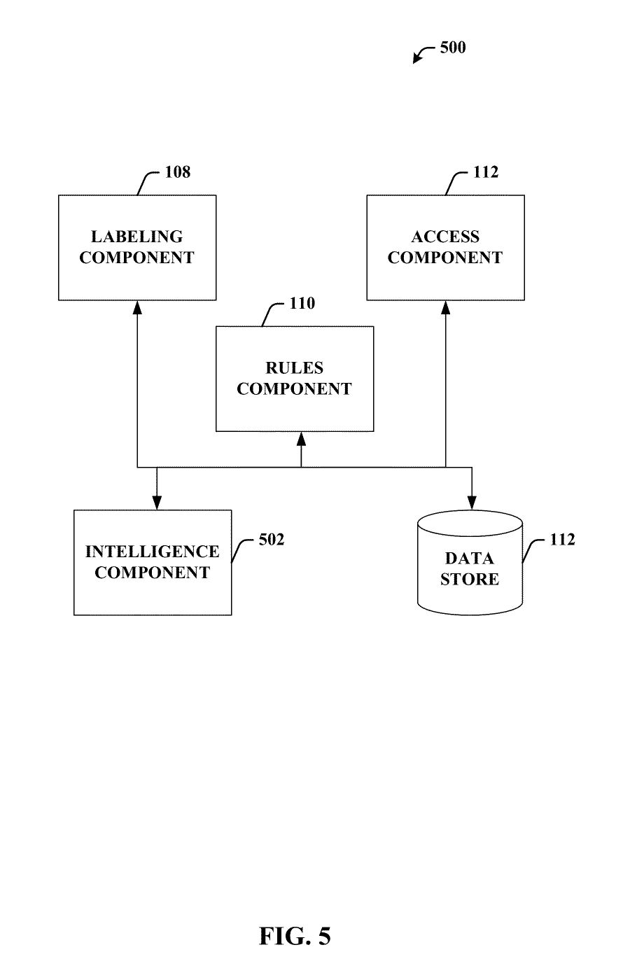

FIG. 5 illustrates an example system 500 that employs an intelligence component 502 that facilitates financial account labeling in accordance with various aspects described in this disclosure. For example, all or portions of the labeling component 108, access rules component 110, and/or access component 114 are operatively coupled to intelligence component 502. Additionally or alternatively, all or portions of intelligence component 502 may be included in one or more components described in this disclosure. The intelligence component 502 can provide for or aid in various inferences or determinations. For example, in one implementation, the intelligence component 502 facilitates generating one or more rules. As discussed previously, the rules component 110 determines or infers a set of rules for funds corresponding to a label (e.g., label 116), and the access component 114 controls, based at least in part on the rules, transactions (e.g., deposits, withdrawals, transfers, balance inquiries, etc.) relating to funds corresponding to the label. The intelligence component 502 can infer or determine one or more rules and/or whether an initiated transaction satisfies the rules, such as, but not limited to, rules for access rules component 110 or funding rules component 112.

Accordingly, in order to provide for or aid in the numerous inferences described in this disclosure, intelligence component 502 examines the entirety or a subset of the data available and provides for reasoning about or infer states of the system, environment, client, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used in this disclosure also is inclusive of statistical regression that is used to develop models of priority.

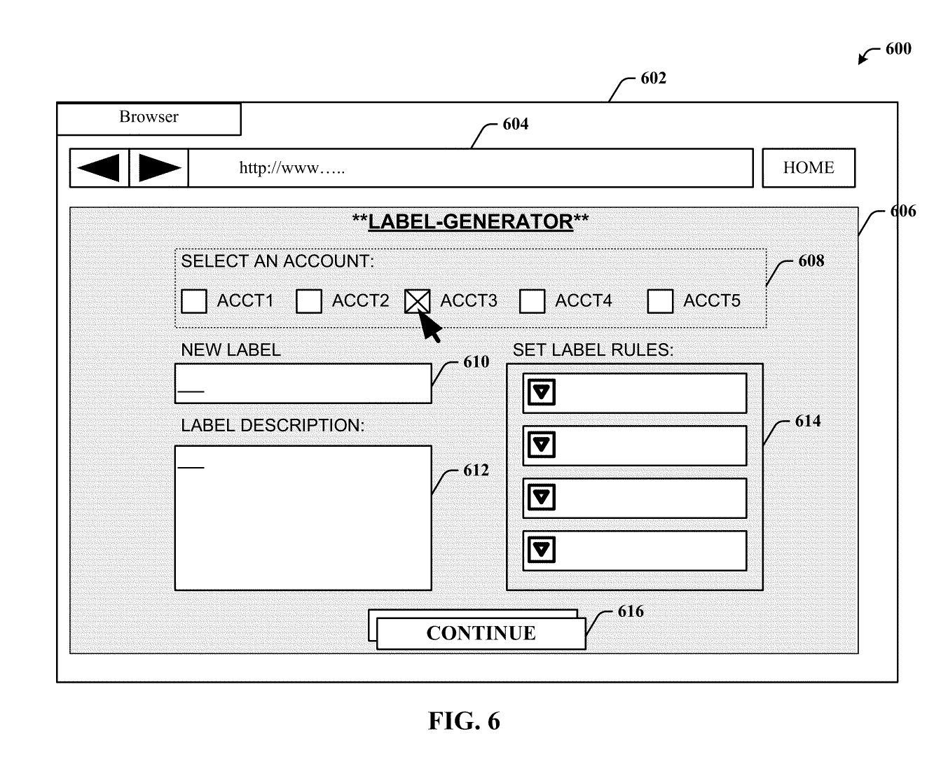

FIG. 6 illustrates an example label generation pane 600 in accordance with various aspects described herein. As discussed previously, the finance component 102 can be associated with an online system (e.g., online banking system, web portal, etc.). The online system can be accessed via a web browser 602 that includes an address bar 604 (e.g., URL bar, location bar, etc.). The web browser 602 can expose a label generation screen 606 that includes an account selection section 608, a label creation field 610, a label description field 612, a rules generation section 614, and a label generation initiation selector 616.

The account selection section 608 can include a set of accounts associated with one or more users (e.g., users 104), and a set of selection fields corresponding to respective accounts included in the set. For example, a user can select a third account (e.g., ACCT3) by clicking or otherwise selecting a selection field associated with the third account. The label creation field 610 provides for the user to determine, enter, or otherwise input a name or title of the label. For example, the label creation field 610 can include a text box, and the user can enter a name of the label (e.g., college tuition), for example, by typing in the text box.

The label description field 612 provides for the user to determine, enter, or otherwise input a description for the label. For example, the label description field can include a text box, and the user can input a description including but not limited to details regarding the label and/or a label purpose, for example, by typing in the text box. The rules generation section 614 provides for the user to set, determine, or otherwise generate a set of rules for the label. For example, the rules generation section 614 can include a set of drop down menus, and the user can select a set of rules included in the drop down menus. The label generation initiation selector 616 initiates generation of the label based at least in part on input provided by the user via the account selection section 608, label creation field 610, label description field 612, and/or rules generation section 614.

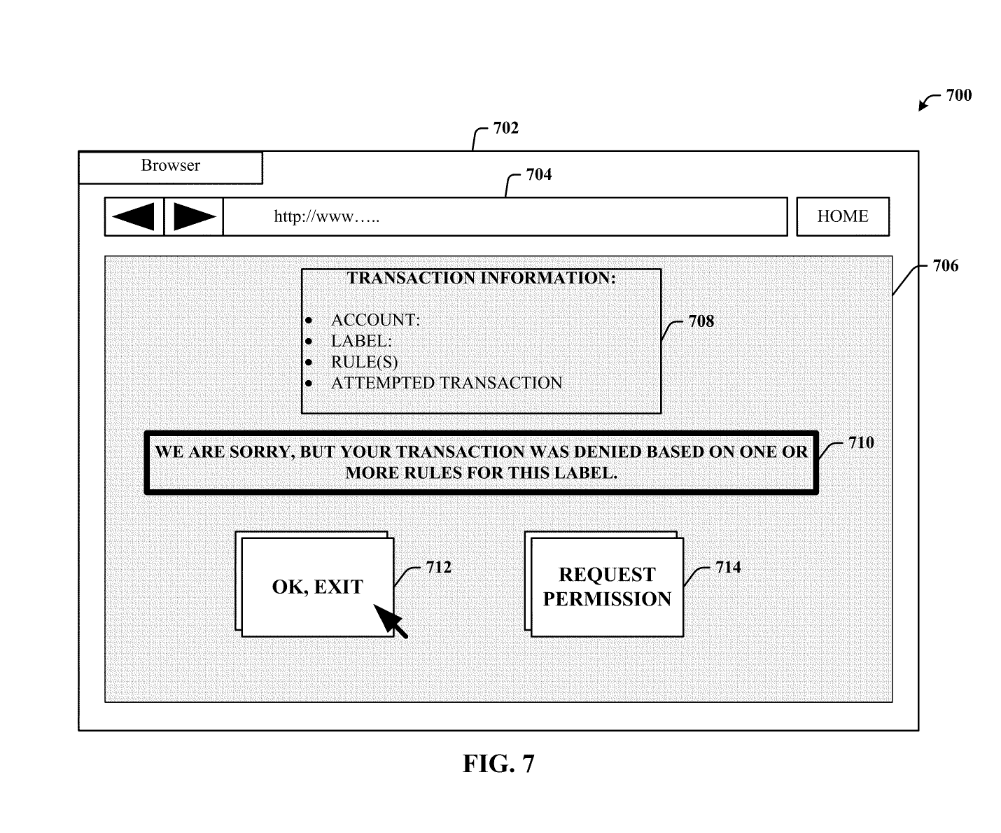

FIG. 7 illustrates an example transaction disposition pane 700 in accordance with various aspects described herein. As discussed previously, access to funds corresponding to a label (e.g., label 116) can be restricted, directed, or otherwise controlled (e.g., using the access component 114 based in part on a set of rules (e.g., determined using the access rules component 110). Access can include but is not limited to transactions including, for example, withdrawals, deposits, transfers, balance inquiries, and/or statement inquiries. The online system can be accessed via a web browser 702 that includes an address bar 704 (e.g., URL bar, location bar, etc.). The web browser 702 can expose a transaction disposition screen 706 that includes a transaction information section 708, a disposition information section 710, a completion selector 712, and/or a permission request selector 714.

The transaction information section 708 provides a user a set of information related to an initiated transaction. The set of information can include but is not limited to an account and/or label associated with the initiated transaction, a set of rules corresponding to the initiated transaction, and/or details associated with the initiated transaction. The disposition information section 710 provides the user information regarding a disposition of the initiated transaction. The disposition can include but is not limited to allowed, denied, and/or restricted. As discussed previously the initiated transaction is compared against a set of rules for the label (e.g., using the comparison component 404), and, based in part on the comparison, the initiated transaction can be allowed, denied, or restricted (e.g., using the enforcement component 406).

The completion selector 712 provides for a user to execute the disposition of the initiated transaction. For example, if the transaction is allowed, then the user can execute or complete the initiated transaction by clicking or selecting the completion selector 712. The permission request selector 714 provides for the user to request permission from one or more other users when the initiated transaction is denied and/or restricted. As discussed previously, in response to an initiated transaction not satisfying one or more rules, permission can be requested from one or more of other users (e.g., using the enforcement component 406). If the permission is obtained, then the transaction can be allowed and/or completed. It is to be appreciated that the subject disclosure is not limited to a particularly display, and that FIGS. 6 and 7 are merely example displays provided in accordance with various aspects described herein.

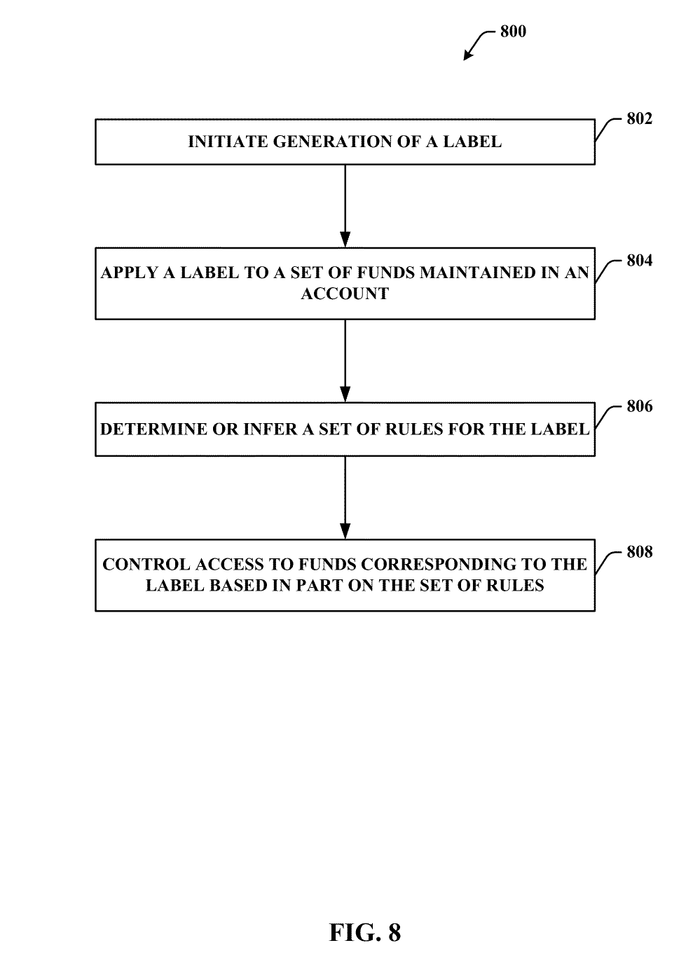

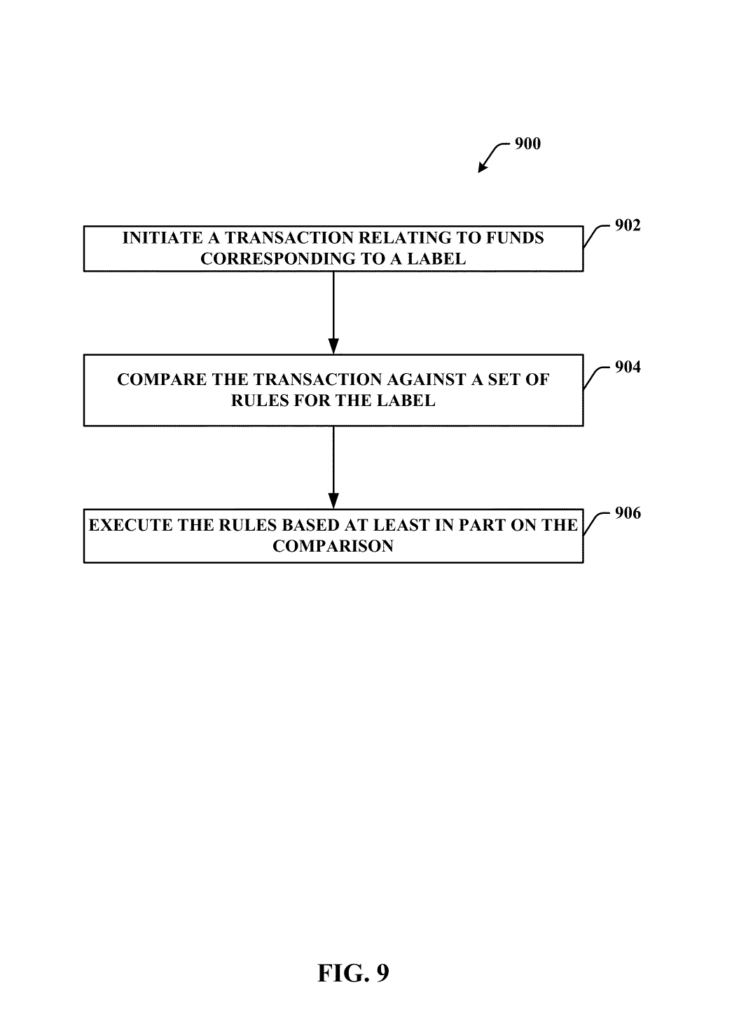

In view of the example systems described supra, methods that may be implemented in accordance with the described subject matter may be better appreciated with reference to the flow charts of FIGS. 8-9. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 8, illustrated is an example methodology for financial account labeling 800 in accordance with aspects described herein. Methodology 800 can begin at block 802, wherein creation, development, and/or generation of a label is initiated (e.g., using the labeling component 108). As discussed previously, input or data related to generating a label for a set of funds maintained in an account can be obtained, acquired, or otherwise received (e.g., using the input label component 202), and the label can be generated based at least in part on the input or data. At 804, the label is applied to a set of funds maintained in the account (e.g., using the association component 204). For example, a set of authorized users can assign, apply, or otherwise associate the label with a set of funds maintained in the account. As an additional or alternative example, one or more the users can generate, create, or otherwise determine a set of association criteria for the label, and the label can be associated with a set of funds maintained in the account based in part on the set of association criteria.

At 806, a set of rules for the label are determined or inferred (e.g., using the access rules component 110). For example, the users can explicitly or implicitly provide one or more rules. As an additional or alternative example, one or more rules can be determined or inferred based in part on based on a set of rule determination criteria. The rule determination criteria can include but is not limited to a type of label (label type), contributions of respective users (e.g., users 104), label title or name, label description, rules for labels associated with associated and/or similar users, identity of users, a primary users, and/or other rules associated with the label. As yet another additional or alternative example, one or more rules can be determined or inferred based at least in part on a collaborative financial plan associated with one or more of the users.

At 808, access to funds corresponding to the label is controlled (e.g., allowed, denied, or restricted) based in part on the rules (e.g., using the access component 114). Access can include but is not limited to transactions including, for example, withdrawals, deposits, transfers, balance inquiries, and/or statement inquiries. For example, only the first user (e.g., user 104A) may be able to view a balance for the account; however, based in part on the rules, respective users in the set of users may be able to view a balance corresponding to the label.

Referring to FIG. 9, illustrated is an example methodology for financial account labeling 900 in accordance with aspects described herein. Methodology 900 can begin at block 902, wherein a transaction relating to funds corresponding to a label is initiated (e.g., using the transaction component 402). As discussed previously, transactions can include but are not limited to withdrawals, deposits, transfers, balance inquiries, and/or statement inquiries. For example, a first user can initiate a withdrawal of funds corresponding to a label.

At 904, the initiated transaction is compared against a set of rules for the label (e.g., using the comparison component 404). Returning to the previous example, the set of rules for the label can include a predetermined withdrawal date, and a date of the initiated withdrawal can be compared against the predetermined withdrawal date to determine whether the initiated withdrawal satisfies the set of rules.

At 906, the set of rules for the initiated transaction, based in part on the comparison, are enforced (e.g., using the enforcement component 406). For example, the transaction can be allowed, denied, or otherwise restricted based in part on the determination of whether the transaction satisfies the set of rules (e.g., determined using the enforcement component 406). Returning to the previous example, if the predetermined withdrawal date is not satisfied, then the initiated withdrawal can be denied. Additional or alternatively, in response to an initiated transaction not satisfying one or more rules, permission can be requested from one or more of other users. Returning again to the previous example, in response to the withdrawal date not being satisfied, permission from a second user can be requested. If the second user provides the permission, then the transaction can be allowed.

### Exemplary Networked and Distributed Environments

One of ordinary skill in the art can appreciate that the various non-limiting embodiments of the financial account labeling systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

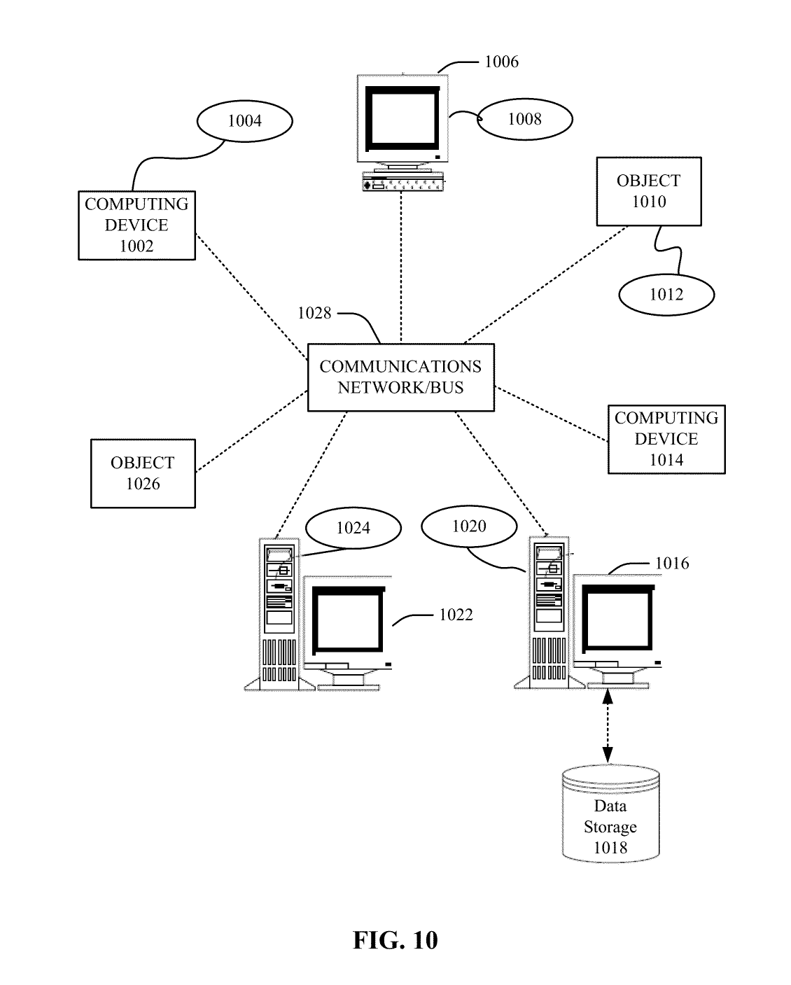

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038. It can be appreciated that computing objects 1010, 1012, etc. and computing objects or devices 1020, 1022, 1024, 1026, 1028, etc. may comprise different devices, such as personal digital assistants (PDAs), audio/video devices, mobile phones, MP3 players, personal computers, laptops, etc.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1040, either directly or indirectly. Even though illustrated as a single element in FIG. 10, communications network 1040 may comprise other computing objects and computing devices that provide services to the system of FIG. 10, and/or may represent multiple interconnected networks, which are not shown. Each computing object 1010, 1012, etc. or computing object or device 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1040 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

### Exemplary Computing Device

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 11 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 11 thus illustrates an example of a suitable computing system environment 1100 in which one or aspects of the non-limiting embodiments described herein can be implemented, although as made clear above, the computing system environment 1100 is only one example of a suitable computing environment and is not intended to suggest any limitation as to scope of use or functionality. Neither should the computing system environment 1100 be interpreted as having any dependency or requirement relating to any one or combination of components illustrated in the exemplary computing system environment 1100.

With reference to FIG. 11, an exemplary remote device for implementing one or more non-limiting embodiments includes a general purpose computing device in the form of a computer 1110. Components of computer 1110 may include, but are not limited to, a processing unit 1120, a system memory 1130, and a system bus 1122 that couples various system components including the system memory to the processing unit 1120.

Computer 1110 typically includes a variety of computer readable media and can be any available media that can be accessed by computer 1110. The system memory 1130 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1130 may also include an operating system, application programs, other program modules, and program data.

A user can enter commands and information into the computer 1110 through input devices 1140. A monitor or other type of display device is also connected to the system bus 1122 via an interface, such as output interface 1150. In addition to a monitor, computers can also include other peripheral output devices such as speakers and a printer, which may be connected through output interface 1150.

The computer 1110 may operate in a networked or distributed environment using logical connections to one or more other remote computers, such as remote computer 1170. The remote computer 1170 may be a personal computer, a server, a router, a network PC, a peer device or other common network node, or any other remote media consumption or transmission device, and may include any or all of the elements described above relative to the computer 1110. The logical connections depicted in FIG. 11 include a network 1172, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” or “a set of criterion” can include one criterion, or many criteria.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims and their equivalents.

1. A system, comprising:
a memory that stores computer-executable instructions; and
a processor, communicatively coupled to the memory, that executes or facilitates execution of the computer-executable instructions to perform operations comprising:
generating a label for a subset of funds maintained in an account associated with an identity;
determining or inferring a set of rules for the label; and
on the set of rules, controlling access, to the subset of funds, by another identity.

2. The system of claim 1, wherein the generating the label is based on data received from a device of the identity associated with the account.

3. The system of claim 1, wherein the operations further comprise:
receiving data from a device of the identity associated with the account, and wherein the determining or the inferring is based at least in part on the data.

4. The system of claim 1, wherein the determining or the inferring is based at least in part on a set of rule determination criteria.

5. The system of claim 4, wherein the set of rule determination criteria includes information indicative of at least one of: a type of the label, a purpose of the label, a contribution of the other identity to the account, a title of the label or a description of the label.

6. The system of claim 1, wherein the determining or inferring is based on accessing electronic information indicative of a collaborative financial plan.

7. The system of claim 6, wherein the electronic information indicative of the collaborative financial plan includes at least one of information indicative of a set of goal data or financial information related to at least one user identity associated with the label.

8. The system of claim 1, wherein the controlling the access comprises controlling at least one of a withdrawal, a deposit, a transfer, a balance inquiry or a statement inquiry relating to the subset of funds.

9. The system of claim 1, wherein the controlling the access comprises at least one of allowing, denying or restricting the access.

10. A method, comprising:
generating, by a system comprising a processor, a label for an account associated with a user identity;
applying, by the system, the label to a subset of a set of funds maintained in the account;
inferring, by the system, a set of rules for the label, wherein the inferring comprises:
adopting, for the label for an account associated with the user identity, a rule for a label for an account associated with another user identity based on a determined level of similarity between the label for an account associated with the user identity and the label for an account associated with another user identity; and
controlling, by the system and based at least in part on the set of rules, access to the subset of the set of funds.

11. The method of claim 10, wherein the generating the label comprises receiving data from a device of the user identity, and generating the label based at least in part on data received from the device.

12. The method of claim 10, wherein the applying the label comprises applying the label based at least in part on a set of association criteria.

13. The method of claim 12, wherein the applying the label based at least in part on the set of association criteria comprises applying the label based at least in part on at least one of a defined portion of deposits made to the account, a defined portion of total funds maintained in the account or an identity of a depositor to the account.

14. The method of claim 10, wherein the inferring the set of rules is also based at least in part on data received from another user identity.

15. The method of claim 10, wherein the inferring the set of rules is based at least in part on a set of rule determination criteria.

16. The method of claim 15, wherein the inferring the set of rules is also based at least in part on information indicative of at least one of: a type of the label, a purpose of the label, a contribution of a third-party identity to the account, a title of the label or a description of the label.

17. The method of claim 10, wherein the inferring the set of rules is also based at least in part on information indicative of a collaborative financial plan.

18. The method of claim 17, wherein the inferring the set of rules based at least in part on information indicative of the collaborative financial plan comprises inferring the set of rules based at least in part on at least one of information indicative of a set of goal data or financial information related to at least one other user identity associated with the label.

19. The method of claim 10, wherein the controlling the access comprises controlling at least one of a withdrawal, a deposit, a transfer, a balance inquiry or a statement inquiry relating to the subset of the set of funds.

20. The method of claim 10, wherein the controlling the access comprises at least one of allowing, denying or restricting a transaction relating to the subset of the set of funds.

21. A non-transitory computer readable storage medium storing computer executable instructions that, in response to execution, cause a device comprising a processor to perform operations, comprising:
receiving information indicative of an initiated transaction relating to a set of funds corresponding to a label;
inferring a set of rules for the label, wherein the inferring comprises:
assigning, for the label for an account associated with the user identity, a rule for a label for an account associated with another user identity based on a determined level of similarity between the label and the label for an account associated with another user identity;
comparing the initiated transaction against the set of rules for the label; and
controlling, based at least in part on the comparing, execution of the initiated transaction.

22. The non-transitory computer readable storage medium of claim 21, wherein the initiated transaction comprises at least one of a withdrawal, a deposit, a transfer, a balance inquiry or a statement inquiry relating to the initiated transaction.

23. The non-transitory computer readable storage medium of claim 21, wherein the controlling the execution comprises at least one of allowing, denying or restricting the initiated transaction.

24. The non-transitory computer readable storage medium of claim 21, wherein the controlling the execution comprises requesting permission to execute the initiated transaction.
